(19) United States
(12) Patent Application Publication
(10) Pub. No.: US 2009/0304763 A1
(43) Pub. Date: Dec. 10, 2009

(54) Insect Attractant Composition

(76) Inventors: Emma Amelia Durand, Jamestown, RI (US); Miaoyong Cao, Warwick, RI (US)

Correspondence Address: JACOBSON HOLMAN PLLC, 400 SEVENTH STREET N.W., SUITE 600, WASHINGTON, DC, 20004, US

(21) Appl. No.: 12/227,645

(22) PCT Filed: Jun. 7, 2007
(86) PCT No.: PCT/US2007/013470

§ 371 Date: Jul. 27, 2009

Related U.S. Application Data
(60) Provisional application No. 60/811,417, filed on Jun. 7, 2006.

(51) Int. Cl. A01N 25/08; A01N 25/02

(52) U.S. Cl. 424/409; 424/84

(57) ABSTRACT

This invention relates to a liquid insect attractant composition containing at least one C₃-C₁₂ ketone, an aqueous solution of lactic acid, and at least one C₁₋₉ fatty acid. The composition may be used in apparatuses capable of releasing the insect attractant composition to lure flying insects into the apparatus.

This is a national stage of PCT/US07/013470 filed Jun. 7, 2007 and published in English, claiming benefit of U.S. provisional application No. 60/811,417, filed Jun. 7, 2006, hereby incorporated by reference.

### FIELD OF THE INVENTION

This invention relates to an insect attractant composition. The composition may be used in an apparatus capable of releasing the insect attractant composition so as to lure flying insects, such as mosquitoes, into a trapping mechanism.

### BACKGROUND OF THE INVENTION

Insects, in particular flying insects such as mosquitoes, have been a nuisance to humans and other mammals for many years. Various formulations have been employed as self-applied lotions or sprays designed to repel the insects from the human body. The most common form of this type of insect repellent is the chemical compound DEET. Besides insect repellents, devices designed to attract and kill flying insects, such as bug zappers, have also been utilized. In areas that are particularly prone to large infestations of flying insects, such as many areas in the northeast United States, fumigation has been used in attempt to destroy the insects in their breeding grounds. Recently, insect-trapping devices have been used to lure insects into the apparatus by emitting a gas, such as carbon dioxide.

However, despite all the various techniques and formulations used to combat flying insects, they remain incorrigible pests to any human adventuring outdoors. Thus, there is a continual need in the art for new and improved methods and compositions that can be used to protect humans from flying insects. This invention answers that need.

### BRIEF SUMMARY OF THE INVENTION

This invention relates to a liquid insect attractant composition, comprising (a) at least one C₃-C₁₂ ketone; (b) at least one C₁-C₉ fatty acid, and (c) an aqueous solution of lactic acid, wherein the fatty acid potentiates the insect-attractant properties of the lactic acid.

This invention also relates to a method of attracting insects, comprising (a) providing a liquid insect attractant composition comprising at least one C₃-C₁₂ ketone, an aqueous solution of lactic acid, and at least one C₁-C₉ fatty acid; (b) providing an apparatus containing a supply capable of holding and releasing the liquid insect attractant; (c) housing the insect attractant composition in the apparatus; and (d) releasing the liquid insect attractant composition from the apparatus in a manner that creates droplets having an average particle size of about 5 microns or less.

This invention also relates to a liquid insect attractant composition, comprising at least one C₃-C₁₂ ketone, an aqueous solution of lactic acid, and at least one C₁-C₉ fatty acid. The liquid insect attractant composition (a) is miscible in water, and (b) has a surface tension less than about 70 dynes/cm at 20° C.

### BRIEF DESCRIPTION OF THE DRAWINGS

FIG. 1 is a profile view of an insect trapping apparatus constructed in accordance with the present invention;

FIG. 2 is a side view schematically showing various internal components of the insect trapping apparatus of FIG. 1;

FIG. 3 is a close-up detail view showing the subject matter in circle A in FIG. 2;

FIG. 4 is a schematic view of selected internal components of the apparatus of FIG. 1;

FIG. 5 is a schematic view showing only the reservoir, the atomizer, the outlet nozzle, and the feedline from FIG. 4;

FIG. 6 is a schematic view with similar components to FIG. 4;

FIG. 7 is a schematic view similar to FIG. 4, but showing an alternative construction where no reservoir is used;

FIG. 8 is a schematic view showing only the fog generator and the feedlines from FIG. 7;

FIG. 9 is a schematic view of a mounting arrangement for removably mounting a fog generator in an open position with the fog generator partially inserted;

FIG. 10 shows the fog generator fully inserted into the mounting arrangement of FIG. 9;

FIG. 11 shows the fog generator fully inserted into the mounting arrangement of FIG. 9 in the closed position;

FIG. 13 is a schematic flowchart for controlling operation of an insect trapping apparatus.

### DETAILED DESCRIPTION OF THE INVENTION

An embodiment of this invention relates to a liquid insect attractant composition, comprising (a) at least one C₃-C₁₂ ketone; (b) at least one C₁-C₉ fatty acid, and c) an aqueous solution of lactic acid, wherein the fatty acid potentiates the insect-attractant properties of the lactic acid. The liquid insect attractant may be used with an apparatus that has the capability of releasing the attractant in a manner that creates droplets or creates a fog plume containing droplets.

The insect attractant composition maybe in the form of a concentrate or a diluted composition. When in a concentrate form, water may or may not be later added to form a diluted composition. Both the concentrated form and the diluted form of the composition are considered within the meaning of a liquid insect attractant composition, as both may act as insect attractants.

The fatty acid preferably ranges from about 1.0 E⁻⁰⁹ to 1.0 E⁻⁰¹ wt. %, more preferably from about 1.0 E⁻⁰⁸ to 1.0 E⁻⁰³ wt. %, most preferably from about 1.0 E⁻⁰⁷ to 1.0 E⁻⁰⁵ wt. %, based on the total weight of the concentrate.

The main difference between the concentrate and the diluted composition lies in the amount of water present in the composition. Because an aqueous solution of lactic acid is a component of the liquid insect attractant composition, the insect attractant composition will contain some amount of water in each form. Water may be added to the insect attractant composition with the lactic acid as part of the aqueous solution, and/or added separately to form a dilute composition. While the water can be added at any time, it is often desirable to add water to the concentrate either before or during the release of the insect attractant composition. Water may be added in any amount desirable.

Water, however, does not have to be added to the insect attractant composition, as the concentrated form of the insect attractant composition may be released without dilution and serve as an effective insect attractant. Releasing the composition, for these purposes, means exposing the liquid composition to the ambient air in a manner that allows the composition to disseminate into the air. The insect attractant composition may be released through the use of an apparatus, through the opening of a container containing the liquid insect attractant composition, or any other technique known in the art that exposes the insect attractant composition to the ambient air.

Any commercially available form of lactic acid may be used. Commercially available lactic acid solutions typically contain 80-85% lactic acid. Alternatively, pure lactic acid, which is solid at room temperature, may be purchased and then diluted to form an aqueous solution of lactic acid.

Depending on the desired end use, the aqueous solution of lactic acid may be diluted before or during the formation of the insect attractant composition. If forming a concentrate, the commercially available lactic acid solution may not need further dilution; if forming an insect attractant composition that is already in a diluted state, the commercially available lactic acid solution maybe diluted, mildly or heavily, with water. Of course, the diluted or concentrate form can both be diluted with water at a later point in time.

The C₃-C₁₂ ketone is any ketone having from 3-12 carbon atoms in the compound. Preferably, the C₃-C₁₂ ketone is acetone, methyl ethyl ketone, 2-methyl-3-octanone, 2-pentanone, 3-pentanone, and combinations thereof. Acetone and methyl ethyl ketone are particularly preferred.

While acetone has been used previously as an insect attractant, copious amounts of acetone must be used to make the acetone effective as an insect attractant. The amount of acetone contemplated for use in this composition, if used alone, would not be sufficient for the acetone to act effectively as an insect attractant. In fact, in one test performed comparing the use of acetone alone versus a composition containing acetone, lactic acid, and the fatty acid, the use of acetone alone lured an average of 6.7% of all available mosquitoes while the composition containing acetone, lactic acid, and the fatty acid lured an average of 72% of all available mosquitoes. It is believed that similar results would be seen using methyl ethyl ketone, 2-methyl-3-octanone, 2-pentanone, 3-pentanone, and other small-chain ketones.

While the C₃-C₁₂ ketones used in the composition are insufficient by themselves to act as an insect attractant; they provide other valuable properties to the composition. In particular, small-chain ketones have the ability to act as surface-active agents and thus provide the composition with a more consistent droplet diameter and a lower surface energy when the liquid composition is released. For instance, a 5% addition of acetone to water can reduce water surface energy from 73 dynes/cm to 56 dynes/cm. While not wishing to be bound by this theory, it is believed that producing a composition with a consistent and smaller diameter size provides a better presentation to the antennae of the flying insects. Presenting droplets of the insect attractant that exhibit a consistent and smaller droplet size stimulates the neurons of the flying insects, drawing the insects towards the attractant composition.

Any commercially available fatty acid having from 1-9 carbon atoms may be used as the fatty acid. Preferably, the fatty acid is contains at least one C₂-C₆ fatty acid. More preferably, the fatty acid is selected from the group consisting of propionic acid, valeric acid, 2-methylbutanoic acid, 3-methylbutanoic acid, and combinations thereof. Most preferably, the fatty acid is a mixture of propionic acid and valeric acid.

The combination of at least one C₃-C₁₂ ketone, at least one C₁-C₉ fatty acid, and lactic acid demonstrates an unexpected, enhanced effect as an insect attractant. That is, the combination of a C₃-C₁₂ ketone, at least one C₁-C₉ fatty acid, and lactic acid achieves superior ability to attract insects as compared to the attractant ability of lactic acid alone. The fatty acids are used in sufficiently small quantities, as compared to the lactic acid, as to provide no measurable ability to attract insects individually. Thus, the C₁-C₉ fatty acids potentiate the attractant properties of the lactic acid. Such a superior effect presents a distinct economic advantage and increases the effectiveness of the lactic acid per unit weight. The ratio of the fatty acids to the lactic acid preferably ranges from 1.0 E⁻⁰⁹:1 to 1.0 E⁻⁰⁴: 1, preferably from 1.0 E⁻⁰⁷:1 to 1.0 E⁻⁰⁵:1.

The main components used in the liquid insect attractant composition, such as the lactic acid solution and the ketone, should have a relatively low molecular weight, preferably below 250, more preferably below 150, and most preferably below 100. Using compounds that have low molecular weights is beneficial because it allows the liquid composition to be lighter, which aids in the distribution during release. Additionally, liquid compositions with lower molecular weights tend to be more miscible with water, which is desirable. For instance, for the aqueous solution of lactic acid, both components (lactic acid and water) have a molecular weight below 100. Preferred ketones, such as acetone and methyl ethyl ketone, also have molecular weights below 100. While it is also preferable for the fatty acids to have a low molecular weight, this is less important because the fatty acids often make up only a relatively small percentage of the total composition weight.

The composition may include one or more surfactants. It is believed that the addition of one or more surfactants assists in creating smaller, more uniform droplets. The use of surfactants is particularly useful when the composition is released in an apparatus that utilizes an outlet nozzle configured in a cone-like shape, where the narrower end of the cone releases the liquid composition. As known in the art, a surfactant has the ability to interact with the other components in a liquid composition to lessen the surface tension of the composition. The release through a cone is preferred because the natural geometry of a cone extenuates the surface area of a liquid traveling through it, so that only a small surface is exposed before the liquid is released. It is believed that lessening of the surface tension provided by the surfactant allows the liquid composition to be released through the end of the cone in a manner that provides smaller, more uniform droplets. Additionally, the lower surface tension reduces the amount of energy necessary to release a droplet, which distributes less energy throughout the composition and generates less of a “heating effect,” which, as known to those of skill in the art, is an undesirable side effect that occurs during the release of the droplet.

Any surfactant known in the art may be used including anionic surfactants and nonionic surfactants. Suitable anionic surfactants include alkyl ammonium salts, bile acids and salts, analogues, and derivatives thereof; fatty acid derivatives of amino acids, camitines, oligopeptides, and polypeptides; glyceride derivatives of amino acids, oligopeptides, and polypeptides; acyl lactylates; mono-, diacetylated tartaric acid esters of mono-, diglycerides; succinylated monoglycerides; citric acid esters of mono-, diglycerides; alginate salts; propylene glycol alginate; lecithins and hydrogenated lecithins; lysolecithin and hydrogenated lysolecithins; lysophospholipids and derivatives thereof; phospholipids and derivatives thereof; salts of alkylsulfates; salts of fatty acids; and sodium docusate. Suitable nonionic surfactants include alkylglucosides; alkylmaltosides; alkylthioglucosides; lauryl macrogolglycerides; polyoxyethylene alkyl ethers; polyoxyethylene alkylphenols; polyethylene glycol fatty acid esters; polyethylene glycol glycerol fatty acid esters; polyoxyethylene sorbitan fatty acid esters; polyoxyethylene-polyoxypropylene block copolymers; polyglycerol fatty acid esters; polyoxyethylene glycerides; polyoxyethylene sterols, derivatives, and analogues thereof; polyoxyethylene vegetable oils; polyoxyethylene hydrogenated vegetable oils; reaction mixtures of polyols and at least one member of the group consisting of fatty acids, glycerides, vegetable oils, hydrogenated vegetable oils, and sterols; tocopherol polyethylene glycol succinates; sugar esters; sugar ethers; and sucroglycerides.

Preferred surfactants include alkyl ammonium salts, alkyl sulfates, alkyl ether sulfates, polyethylene glycol fatty acid esters, polyglycerol fatty acid esters, sugar esters, and sugar ethers. Sodium lauryl sulfate, ammonium lauryl sulfate, sodium lauryl ether sulfate, and ammonium lauryl ether sulfate, and sugar ester amino acids represent particularly preferred surfactants.

Another embodiment of the invention relates to a method of attracting insects, comprising (a) providing a liquid insect attractant composition comprising a C₃-C₁₂ ketone, an aqueous solution of lactic acid, and at least one C₁-C₉ fatty acid; (b) providing an apparatus containing a supply capable of holding and releasing the liquid insect attractant; (c) housing the insect attractant composition in the apparatus; and (d) releasing the liquid insect attractant composition from the apparatus in a manner that creates droplets having an average particles size of about 5 microns or less.

At or before the point where the apparatus releases the insect attractant composition, the composition should be in a diluted form. The insect attractant composition may be placed in the apparatus in a concentrated form, in which case the apparatus can dilute the concentrate with a second liquid before release. Alternatively, the insect attractant composition may be placed in the apparatus in a diluted form and then released by the apparatus.

The amount that the insect attractant composition should be diluted is readily determinable by one of skill in the art. For example, when the insect attractant composition is released using water as the diluent, water preferably represents at least 50% by weight of the total diluted composition; more preferably at least 75% by weight of the total diluted composition; even more preferably at least 90% by weight of the total composition; and most preferably, water represents at least 95% by weight of the total composition.

The droplets should have an average particle size of about 5 microns or less, preferably about 3 microns or less, more preferably about 2.5 microns or less, more preferably about 2 microns or less, and most preferably about 1.5 microns or less.

While it is desirable to control the average particle size of the droplet, it is also desirable to control the percentage of droplets that that are present in certain size ranges. For instance, it is desirable to release the liquid insect attractant in a manner such that at least 50% of the droplets are 3 microns or less in diameter; more preferably at least 65% are 3 microns or less; and most preferably at least 70% are 3 microns or less. Additionally, it is preferable to have 60% of the droplets be less than 5 microns in diameter, and more preferable to have 70% of the droplets be less than 5 microns. Preferably, at least 40% of the droplets are 1.5 microns or less in diameter, and more preferably at least 50% of the droplets are 1.5 microns or less.

The droplet size ranges described above are particularly desirable when the liquid composition is used in an apparatus capable of releasing the composition in a plume, such as a fog plume. It is believed that the plume generated from the liquid insect attractant in the apparatus will behave much like the CO₂ plumes generated by similar devices using carbon dioxide as the attractant. That is, it is believed that the fog plume will spread away from the apparatus in a low lying manner close to the ground. This creates a desirable plume geometry, which is believed to be attractive to insects. Additionally, it has been observed that many flying insects, such as mosquitoes, typically fly within 12 or 24 inches from the ground. Therefore, creating a plume that has the ability to infiltrate this area is seen as advantageous to luring the flying insects towards the release mechanism.

The droplet-size ranges described are also believed to be desirable because they may more easily permeate an insect's sencilla, thus better attracting the insect to follow the plume. As droplet particles are released from the plume, they gradually become smaller to the point where, it is believed, the droplets are able to permeate the sencilla of an insect. Under this theory, smaller droplets therefore have a better opportunity to permeate the sencilla than larger droplets. Of course, different insects exhibit different behaviors and sensing capabilities, and droplet size effect may vary among different insects (or different species of the same insect type).

The apparatus preferably comprises a feeder for feeding the attractant and a fog generator that is in communication with the feeder that operates the releasing step. A preferred apparatus is an insect-trapping apparatus, such as that disclosed in U.S. Provisional Application No. 60/696,523 filed on Jul. 6, 2005, herein incorporated by reference in its entirety. Other suitable insect-trapping apparatuses include those disclosed in U.S. Pat. Nos. 6,145,243; 6,840,005; and 6,892,492; and U.S. Published Patent Application Nos. 2004-0244276 and 2004-0237382.

For instance, a preferred insect-trapping apparatus is an insect trapping apparatus that has a fog generator for generating a fog with an insect attractant composition. The apparatus comprises a frame providing at least one outlet opening and at least one inlet opening. Each of the outlet and inlet openings are communicated, either directly or indirectly, to a surrounding atmosphere. An insect trap chamber is communicated to the surrounding atmosphere through the at least one inlet opening. At least one airflow generator is operable to generate an inflow flowing inwardly from the surrounding atmosphere through the at least one inlet opening and then into the insect trap chamber. This enables the inflow to draw insects attracted to the apparatus into the insect trap chamber.

When a concentrated insect attractant composition is used in the apparatus, the apparatus should have the ability to house both the insect attractant composition and a second liquid, i.e. water, that serves as the diluent to the concentrated insect attractant composition. Preferably, this is done through the use of two separate containers. The term container refers to any structure that can contain a liquid for use in the apparatus, and may be an integral part fixed to the apparatus, or a removable part. The concentrated insect attractant composition may be packaged in a pouch or packet that is designed to fit in one such container in the apparatus. The other container may then be used to hold the diluent. By adjusting the size of the containers to allow for a certain amount of concentrate in relation to a certain amount of water, a skilled artisan could control the ratio of concentrate to diluent when the two liquids are released.

Alternatively, the insect attractant composition may be housed in the apparatus as a diluted insect attractant composition. An insect attractant composition that has been prepared in a diluted form may be directly housed in the apparatus, or the concentrate may be diluted with water to form a diluted composition before being housed in the apparatus. Because the insect attractant is already sufficiently diluted before being housed in the apparatus, only one container that has the capabilities of housing the premixed or diluted insect attractant composition is necessary.

The preferred apparatus also contains a feeder for feeding the liquid attractant composition, and a fog generator is in communication with the feeder such that the feeder feeds the liquid attractant composition supply to the fog generator. The fog generator is also preferably in communication with the at least one outlet opening and is operable to generate a fog comprising the insect attractant composition for exiting through the at least one outlet opening for attracting insects to the apparatus. As disclosed above, the outlet may be an outlet nozzle, such as outlet nozzle in the shape of a cone where the diluted insect attractant composition is released through the tip, or narrower end, of the cone. It is believed that when the outlet nozzle is in the shape of a cone, it is easier to control the release rate of the diluted insect attractant composition.

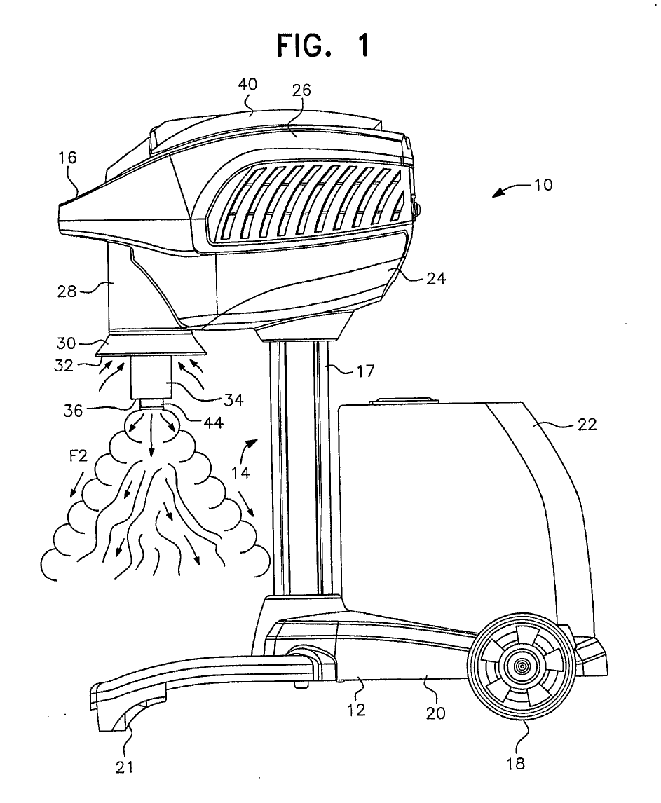

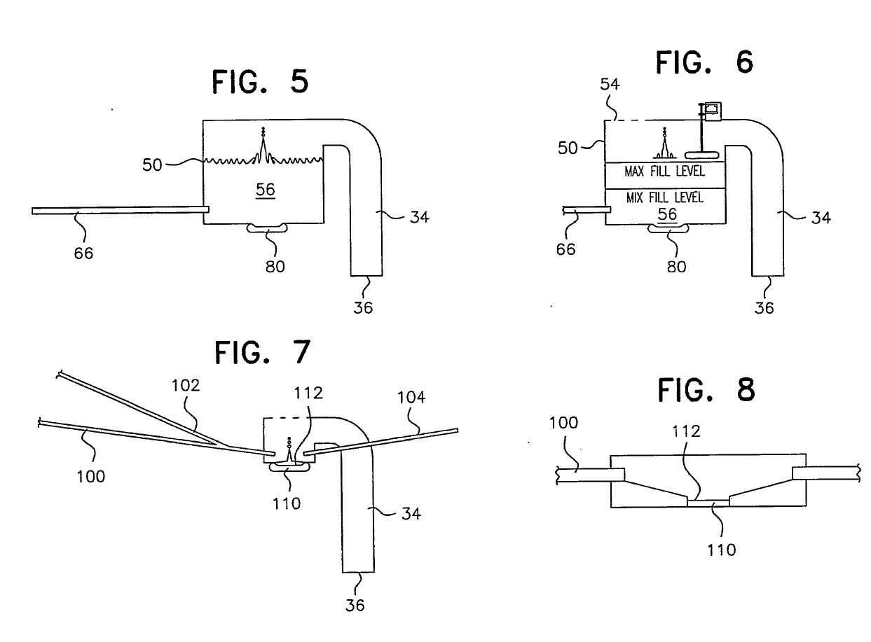

The following insect-trapping apparatus represents a preferred apparatus that may be used with the insect attractant composition with reference to FIGS. 1-13.

FIG. 1 shows an exemplary flying insect trapping apparatus, generally indicated at 10, constructed in accordance with the present invention. Broadly speaking, the general function of the device 10 is to emit a fog F with at least one insect attractant to attract mosquitoes and other flesh biting insects. Then, an inflow draws the attracted insects into a trap chamber within the device, where the insects are captured and killed by poison or dehydration/starvation. Alternatively, a user engaged in the study of insects may opt to not kill the captured insects and instead may remove them from the device 10 prior to dying for purposes of live examination. Regardless of the specific insect capturing purpose the user has in mind, the overall function of the device 10 is to attract and capture flying insects. The specifics of how the present invention operates to achieve this broad general function is discussed herein below.

The device 10 comprises a supporting frame structure, generally indicated at 14. The supporting frame 14 includes a housing 16 supported on a single vertically extending leg 17 that extends upward from a base 12. In the illustrated embodiment, one leg 17 is used to support the housing 16, although multiple legs may be used, or other structures besides legs could be used. Additionally, the frame may include wheels 18, as shown in FIG. 1. Further, the supporting frame 14 may also include a supporting deck 20 for carrying a container 22, which will be discussed below, so that the frame 14 and the container 22 can be transported together as a unit. As illustrated, the wheels 18 are rotatably mounted at one longitudinal end portion of the base 12 under the deck 20, and a pair of supporting legs 21 are mounted at the opposite longitudinal end portion of the base 12.

The supporting frame 14, however, may have any construction or configuration suitable for carrying the operative components discussed herein below. For example a tripod arrangement may also be used, or the apparatus may be built so as to be mounted to a wall or fence, as is shown in U.S. patent application Ser. No. 10/686,815. Any other suitable configuration may be used.

The housing 16 includes a bottom shell 24 and a top shell 26 mounted thereto. The shells 24 and 26 are coupled and secured together using conventional fasteners, adhesives, a snap-fit relation, or in any other suitable manner. In the illustrated embodiment, these shells 24 and 26 are molded from plastic; however, these shells 24, 26, and the housing 16 in general, may be made from any materials and may take any shape, configuration, or construction.

A tubular intake nozzle 28 protrudes downwardly from the bottom shell 24 and is formed integrally therewith. The intake nozzle 28 has a flared lower end 30 which is attached by fasteners or snap-fitting to, and thus forms apart of, the intake nozzle 28. The flared lower end 30 defines an insect inlet or inlet opening 32. As will be appreciated from the details provided hereinbelow, a vacuum is applied tq the nozzle 28 and the insects attracted to the fog F emanated by the device 10 will be drawn into the insect inlet 32 for capture. The intake nozzle 28 and the inlet 32 provided thereby may be carried on the frame 14 in any suitable manner and the construction illustrated and described is only an exemplary construction. Thus, other configurations may be used.

Concentrically mounted within the intake nozzle 28 is an outlet nozzle 34. The outlet nozzle 34 provides a fog outlet or outlet opening 36 on the lower end thereof. The function of the outlet nozzle 34 and its outlet 36 is to allow the fog F generated to flow outwardly and downwardly therefrom. Mosquitoes and other insects attracted to the fog F will be able to sense it and follow the same to its source, namely the outlet 36. As can be appreciated from the construction disclosed, because the outlet nozzle 34 is concentric with the intake nozzle 28, the attracted insects fly to the source of the fog F (i.e., the outlet 36) and will be immediately adjacent the insect inlet 30 upon reaching the outlet 36. As a result, the attracted insects may fly into the vacuum zone created by the vacuum communicated to the intake nozzle 28 and its insect inlet 30, whereby they are drawn into the device 10 and captured therein. The respective flows of the vacuum intake and the fog F outflow are indicated by the inflow and outflow arrows in FIG. 1. For further details and variations on this aspect of the disclosed construction, reference may be made to the patents and applications mentioned above. Also, reference may be made to U.S. Pat. No. 6,286,249, herein incorporated by reference in its entirety.

The upper shell 26 of the housing 16 includes an access door 40 that can be moved between open and closed positions to open and close an access opening formed in the housing wall. The door 40 may be pivotally mounted to the upper shell 26 to facilitate its opening and closing movements by pivot pins or other structures. In the broader aspects of the invention, the door 40 maybe entirely separable from the housing 16, or may be connected for opening and closing movements using any suitable construction. In fact, the provision of the door 40 is not necessary at all and is simply a feature for convenience. The role of the access door 40 and its associated opening is to enable a user to gain access to the interior of the housing 16, but its provision is not necessary.

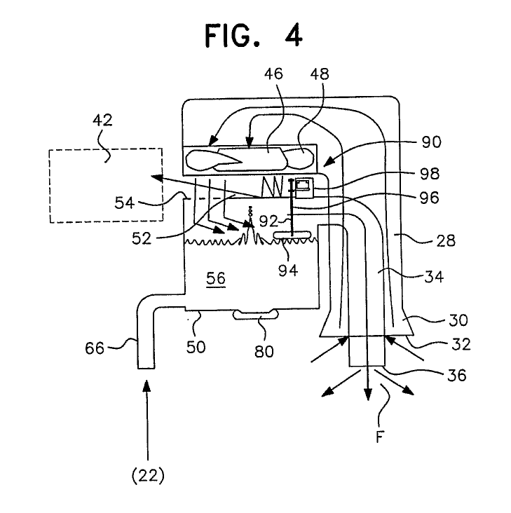

As will be described in further detail below, a mesh bag 42, the interior of which defines an insect trap chamber, is removably mounted within the housing 16. The mounting and use of such a bag is well-known, and it is shown schematically in FIG. 4. The chamber defined by the bag 42 is communicated to the insect inlet 30 so that the insects drawn in by the vacuum will be deposited in the bag 42 whereat they will become dehydrated and perish. Alternatively, the material of the bag 42 may be treated with a poison for purposes of facilitating the insect termination function; however, that is not a necessary feature of the invention. The access door 40 and its associated opening permit access into the interior of the housing 16 to allow the user to access the mesh bag 42 as desired for purposes of removal/replacement. Also, as another alternative, a plastic box or any other suitable structure may be used in place of mesh bag 42. In the disclosed embodiment, the door 40 is formed from a transparent material to enable the user to visually inspect the bag 42 to determine whether it needs removal/replacement, Specifically, the transparent material may enable the user to visually verify whether the bag 42 is at or near its full capacity of insects. In the broader aspects of the invention, the door 40 need not be transparent, and further, as mentioned previously, the device does not necessarily require the door 40 and its associated opening. For further details with regard to the mounting or access to the mesh bag 42, or other insect trap chamber, reference may be made to the patents/applications mentioned above.

An optional lure may be mounted in a housing 44, which is shown as being mounted inside the outlet nozzle 34. The construction of such a housing is known from other applications, such as U.S. Patent Application No. 2005-0019361 A1, and is not described in detail herein.

As mentioned above, the frame provides at least one outlet opening 36 and at least one inlet opening 32. Each of the outlet and inlet openings 32, 36 are communicated to the surrounding atmosphere. They may be provided on the frame 14 in any way and the illustrated concentric structure is not intended to be limiting. Instead, any suitable location for these openings may be used, and more than one of each or both openings may be used.

The mesh bag 42 provides the insect trap chamber, which is communicated to the surrounding atmosphere through the inlet opening 32. Specifically, as shown in FIG. 4, the inflow entering the inlet opening 32 is directed up the nozzle 30, then through a fan 46, and then into the mesh bag 42. Constructions for directing an inflow are well-known and need not be described herein in detail. Reference may be made to any one of the applications incorporated herein.

At least one airflow generator is provided, and in the illustrated embodiment this is provided by the fan 46. The fan 46 includes a motor that draws an electrical power signal and rotates its blades 48, thereby generating the inflow. Specifically, the fan 48 is operable to generate the inflow so that it is flowing inwardly from the surrounding atmosphere through the inlet opening 32 and then into the insect trap chamber provided by the mesh bag 40. This enables the inflow to draw insects attracted to the device into the insect trap chamber of the bag 40.

As can be seen in FIG. 4, a reservoir 50 is provided for the fog generator, which will be described below. The reservoir 50 has a top wall 52 with a series of openings 54. These openings 54 enable a portion of the airflow generated by the fan 46 to be diverted into the reservoir for purposes of exhausting the fog generated therein through the outlet opening 36.

The airflow generator may be provided by a single fan as shown, or by multiple fans. Further, airflow may be generated by any other suitable device or devices for generating the inflow. Moreover, it is not necessary that the airflow generator be used to exhaust the fog outflow, although that is preferred. Any other suitable construction or arrangement may be used in place of the one illustrated.

The apparatus 10 also includes an attractant supply comprising an insect attractant and a supply of a liquid. This terminology is intended to encompass a wide range of embodiments. For example, the attractant supply could be constituted by a mixture or solution of an insect attractant and a base liquid in a single container. It also could be constituted by an insect attractant and a base liquid housed in separate containers. The base liquid may be any suitable liquid, such as water. Water is preferred because of its availability and low cost.

The insect attractant maybe of any type suitable for attracting insects and may be in liquid or solid form. If it is in solid form, it is preferred that the attractant be in particulate form so that it more easily mixes into the liquid. Examples of suitable attractants are those having a molecular weight below 100, such as butyric acid and fatty acids (e.g. C4, C5, and C6 fatty acids). It is preferred that such attractants have high miscibility. Other attractants may also be used, such as those of a higher molecular weight, or having a lower miscibility, and the invention is not intended to be limited to the examples given.

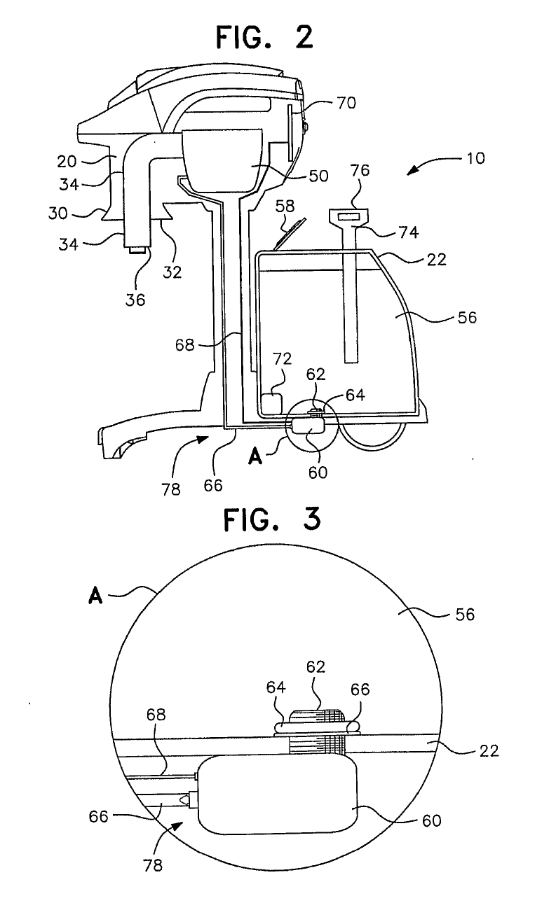

In the embodiment of FIGS. 1-4, the attractant supply is the liquid, preferably water, and the attractant mixed together as a solution. This solution is contained in container 22. The attractant and water solution is indicated at 56. The container has a lid 58 that covers an opening on the top wall of the container 22. FIG. 1 shows the lid closed, and FIG. 2 shows it open. The user may open the lid 58 for filling up the container 22. When the liquid used is water, the user would preferably fill the container with a hose, or from some other source of water. The attractant would be provided in a liquid or particulate form that the user could mix into the water to create the attractant/water solution 56.

Instead of the attractant being in solution in the water, the attractant and the water could merely be a mixture. A solution is preferred, because solutions do not separate, whereas in a mixture the attractant may fall out to the bottom of the container 22 over time. To avoid this, a small propeller or other agitator (not shown) may be placed in the container 22 if a mixture is to be used, thus allowing the mixture to be continuously mixed and prevent the attractant from separating or falling out.

FIG. 2 shows a pump 60 that is mounted underneath the container. The pump 60 is externally mounted, and has an inlet 62 that is inserted through an opening formed in the bottom wall of the container 22. This enables the pump 60 to draw the solution 56 from the container 22. To secure the pump 60 and its inlet tightly in a sealed manner, the inlet 62 is externally threaded and an internally threaded annular ring 64 is threaded onto the inlet. An annular gasket or seal 66 is provided between the ring 64 and the internal surface of the container's bottom wall to prevent leakage of the solution 56. The pump 60 has an outlet 64 to which a feed line 66 (such as plastic or metal tubing) is attached. Also, a power cord 68 is connected to the pump 60 and delivers power to the pump 60 for its operation. The power cord 68 is connected at its opposite end to a controller 70, which will be discussed later.

The pump 60 maybe of any type and have any construction or configuration. The illustrated pump 60 and the method by which it is mounted is not intended to be limiting.

As an alternative, a submersible pump 72 could be provided inside the cntainer 22 in lieu of the external pump 60. With this type of pump 72, the feedline 66 would be connected to it through an opening in the container wall in any well known manner for making such a connection.

As another alternative, a manual pump 74 may be provided. This manual pump 74 may be used in lieu of a powered pump, or in addition to a powered pump as a back-up in the event the powered pump fails. The manual pump 74 is of a well-known construction and has a handle 76 for grasping and facilitating a pumping action. The manual pump 74 operates by increasing air pressure in the space above the solution/mixture 56 so as to force the solution/mixture 56 into the feedline 66.

The pump 60 and the feedline 66 maybe considered as constituting a feeder 78 for feeding the attractant and the liquid. Likewise, any of the other alternative pumps mentioned above, or any other device for feeding the attractant and the liquid, whether together in a solution/mixture or separate, maybe considered as comprising a feeder for feeding the attractant and the liquid. Any suitable mechanism, system or device for feeding the liquid and the attractant may be considered as being a feeder.

A fog generator 80 is in communication with the feeder 78 such that the feeder 78 feeds the attractant supply to the fog generator 80. In the embodiment of FIGS. 1-4, this feeder 74 feeds the solution 56 from the container 66 to the reservoir 50. Specifically, the pump 60 pumps the solution 56 through feedline 66, which is connected at its opposite end to the reservoir 50. The fog generator 80 is mounted to the bottom wall of the reservoir 50.

The fog generator 80 used in this embodiment is of the submersible type and is operable to generate a fog from the solution in the reservoir 50. This fog F exits through the outlet nozzle 34, as the outlet nozzle 34 is in communication with the reservoir 50 and hence the fog generator 80 as shown in FIG. 4. Because the attractant and the liquid are in a solution or mixture together, the fog F will comprise droplets of the liquid and the attractant, which will ultimately exit the outlet opening 36 for attracting insects to the apparatus 10.

Preferably; the fog generator 80 is an electromechanical device. More preferably, the generator 80 is an ultrasonic device operable to vibrate at ultrasonic frequencies to generate the fog F. Such devices are known in the art, and need not be described herein in detail. They are sometimes referred to as atomizers or nebulizers. Preferably, but not necessarily, the fog generator 80 would be connected by wiring to the same controller 70 as the power cord 68 so that the delivery of electrical power to the fog generator 80 can be selectively controlled. Other types of devices for generating the fog F may also be used, and the invention is not intended to be limited to any one specific type.

Examples of suitable ultrasonic fog generators are available from APC International, Ltd., located in Mackeyville, Pa. For example, a ceramic piezoelectric crystal type one may be used. From APC, examples for suitable model numbers for use are 50-1010 (1.65 MHz Nebulizer Board) and 50-1025 (2.4 MHz Nebulizer Board). Reference may be made to the APC's website for information on those models: http://www.americanpiezo.com/products_services/nebulizers.html.

According to that website:

$$droplet diameter = 0.73 \times \sqrt{3} \frac{surface tension of liquid}{( density of liquid ) ( input {frequency}^{2} )}$$

Thus, the frequency of the generator selected has an effect on the resulting droplet size, among other factors. Accordingly, the frequency may be chosen may be used to produce droplets within desired ranges. The range of 1.65 to 2.4 MHz, of which these APC examples are representative, is suitable for generating a fig with appropriate size droplets. Other frequencies outside that range may also be used.

In lieu of an ultrasonic device for generating fog, it is possible to use a misting nozzle type of approach to disperse the liquid into fine particles. The use of an ultrasonic device is preferred, as nozzles are susceptible to clogging and other issues. However, the use of a nozzle is within the scope of the invention.

FIGS. 4 and 6 show the optional addition of a reservoir level sensor 90. As an example, this may be a float switch 92. The float switch has a buoyant float member 94 that floats in the reservoir 50 and is mounted to a rod 96. The upper end of the rod 96 is connected to a sensor 98. The sensor may be any suitable sensor, such as one using one or more magnetic switches or reed switches. The float 94 will rise and fall as the level of the liquid 56 in the reservoir 50 rises and falls. The sensor 98 is used to monitor the level of the liquid in the reservoir 50 by monitoring the height of the rod 96, which is attached to the float 94. The sensor 98 is also used to control the pump 60, and may be either electrically coupled directly to the pump 60, or to the controller 70. Either way, when the sensor 96 detects that the float 94, and hence the liquid level in the reservoir, is above a predetermined minimum fill level, the pump 60 will remain inactivated, as there is no need to pump additional solution/mixture into the reservoir 50. If the pump 60 is running and feeding liquid to the reservoir 50, the sensor 96 can be used to cease operation of the pump 60 upon the float 94, and hence the liquid level in the reservoir 50, reaching the maximum fill level. Likewise, if the float 94, and hence the liquid level in the reservoir 50, falls below the minimum fill level, the sensor 96 can detect this and be used to start operation of the pump 60 so that additional solution/mixture 56 is fed into the reservoir.

With the use of this sensor system, it can be ensured that the liquid level is within the proper range for enabling the fog generator 80 to operate and generate fog F. The range can depend on factors such as the type of fog generator 80 used, the frequency at which it is driven, etc.

The controller 70 manages the functions of the various parts. Preferably, the controller 70 includes a processor and/or dedicated circuitry for this purpose. The controller 70 controls the delivery of electrical power to the fog generator 80, the pump 60, and the motor of the fan 46. The controller 70 preferably connects to and receives power from a power source, such as a standard AC outlet. When the trap is not in use, no power is delivered to any of the components by the controller 70. When the trap is started by a user, the controller 70 can begin delivering power to the fan 46. Preferably, it also detects the state of the float switch sensor 96 to determine whether the liquid in the reservoir 50 is below the minimum fill level. If it is above that level, then it would begin delivering power to operate the fog generator 80; and if it is not, it would first deliver power to operate the pump 60 to supply the solution/mixture 56 to the reservoir 50. Once a satisfactory amount of liquid is in the reservoir 50, then the fog generator 80 would be supplied with power.

This control scheme for the controller 70 may be varied, and the one described above is not intended to be limiting. The scheme may vary based on the specific types and numbers of components used. Likewise, no particular order of steps or acts is particularly necessary.

FIG. 13 illustrates an exemplary flowchart for controlling the operation of the apparatus 10. This logic may be hardwired into the circuitry of the controller 70, or provided in software format. This flowchart is exemplary only and is not intended to be limiting.

In block 300, the user has pushed or otherwise activated the START or ON switch of the apparatus 10. In block 302, the user has pushed the STOP or OFF switch of the apparatus. These switches could be provided by a single switch, such as of the toggle type, or by separate switches. Such a switch may be of any construction, and would be provided on a user panel on the exterior of the apparatus.

Following from block 302, when the user has pushed or otherwise activated the STOP or OFF switch, in block 303 all functions of the apparatus 10 are terminated, and the logic ends at block 310.

Following from block 300, the next step is for the controller 70 to run a self diagnostic check per block 304. These checks are well known and are not described herein. If the check fails, the logic proceeds to block 306 where all functions of the apparatus 10 are terminated. Then, in block 308, an LED is activated to blink at a fast rate. This LED would preferably be located near the ON/OFF switch on the exterior of the apparatus 10, and would signal an error in the apparatus to the user.

If the check passes, then a green LED is activated in block 312. This LED would preferably be located near the ON/OFF switch on the exterior of the apparatus 10, and would signal to the user that the apparatus is beginning to function. Next, the fan 46 is activated in block 314. Then, in block 316, the controller 70 determines whether the level sensor 90 is at the maximum fill level.

If the level sensor is sensed as not being at the maximum fill level, then the pump is activated in block 318 and a timer T3 is started. In block 320, if the timer T3 has not reached 60 seconds, the logic loops back to block 316 to check whether the level sensor is sensed as being at the maximum fill level. If it is, then the logic proceeds on to block 326. If it is not, then the logic returns to block 320 through block 318 (the timer T3 is not restarted this time though). This loop will continue until either the level sensor 90 reaches the maximum fill level (thus proceeding the logic to block 326) or the timer T3 reaches 60 seconds.

If the timer has reached 60 seconds, this indicates that the supply has run out, and the logic moves to block 322 where the pump is turned off. Then the blinking LED mentioned above is activated to blink slowly, indicating to the user that the supply needs to be re-filled. The logic then proceeds to block 310 to end the process.

In the situation where either the level sensor 92 is initially at the maximum fill level, or where it becomes so within 60 seconds as a result of the pump operating in block 318, the logic proceeds to block 326. In this block, the pump is turned off. Next, in block 328, the fog generator is activated and timer T1 is started. Block 330 determines when timer T1 reaches 10 seconds. Upon reaching 10 seconds, the generator is stopped in block 332 and timer T2 is started. Block 334 determines when timer T2 reaches 10 seconds. These operations are repeated in blocks 336, 338, 340, and 342. This results in the fog being generated in “bursts” or “pulses.” This is desirable for at least two reasons. First, it allows the fog to be released in incremental amounts, somewhat akin to mammalian exhalations, the typical prey of mosquitoes. Second, steady streaming of the fog may cause some of the droplets to “collide” as the fog is working its way out of the device, thus possibly forming larger droplets that become too large to be airborne.

After block 342, the logic then returns to block 316, where the process continually repeats as described.

This exemplary flowchart is not limiting. Any of the variables may be changed, and any other suitable logic, steps, or sequences may be used.

In alternate embodiments, the attractant supply could comprise a liquid container containing the liquid and an attractant container containing the attractant separately from the liquid. This would be in lieu of keeping the liquid and the attractant together in the same container. There are various reasons for using separate containers, which may be dependent on the attractants used. For example, if a certain attractant could lose efficacy if exposed to water for a long period of time, it would be desirable to house and store that attractant in a separate container.

To manage delivery of the supply from different sources, the feeder may include a liquid feeder for feeding the liquid to the fog generator and an attractant feeder for feeding the attractant to the fog generator. FIGS. 7 and 8 show such an arrangement, where tube 100 is the liquid feeder and tube 102 is the attractant feeder. Another tube 104, which could be used in lieu of or in addition to tube 102, is also used as an attractant feeder. As can be seen from FIG. 7, attractant feeder tube 102 merges into liquid feeder tube 100 so that the liquid and attractant delivered by those tubes are mixed together just prior to delivery to the fog generator 80.

The use of separate attractant and liquid feeder could be implemented with the embodiment illustrated ip FIGS. 1-6 if desired. However, as illustrated, these feeders 100, 102 and 104 (if used) deliver the liquid and attractant(s) directly to the surface of a non-submersible fog generator 110. The liquid and the attractant are fed to form a film on an operative surface 112 of the generator 110, which is the surface that faces upwardly. The generator 110 is preferably electromechanical, such as an ultrasonic device operable to vibrate at ultrasonic frequencies to generate the fog F from the film on the operative surface 112 of the ultrasonic device.

To maintain the film on the surface 112 of the fog generator 110, the feeder is operable to continually feed the liquid and the attractant to form the film having on the operative surface 112 with a thickness that stays within a desired range. A preferred range for film thickness is 1 to 2 inches, but that range may vary based on certain factors. A range of 1-1.75 inches is preferred. These ranges may be used with any of the devices described above, or other devices. When used with devices in the ranges of 1.65 to 2.4 MHz, these film thicknesses generate droplets in desired ranges, which are discussed below.

To achieve this, any well known metering devices or pumps maybe used. The specific type and construction of such devices would depend on the specific characteristics of the liquid or attractant being fed. Also, the metering could be achieved by gravity feed for either the liquid or the attractant if desired, which eliminates the need for a pump. For such an application, it would be desirable to use a valve for controlling flow. In general, any suitable construction or arrangement may be used.

In another embodiment, the attractant supply could comprise a container containing the liquid and the attractant mixed together, as shown in the embodiment of FIGS. 1-6, and the feeder feeds the liquid and the attractant mixed together into the reservoir such that the level of the mixed liquid and attractant in the reservoir is maintained to form the film on the operative surface of the ultrasonic device. This combines the formation of a film in the embodiment of FIGS. 7 and 8 with the single container of FIG. 1-6 for storing the liquid and attractant together.

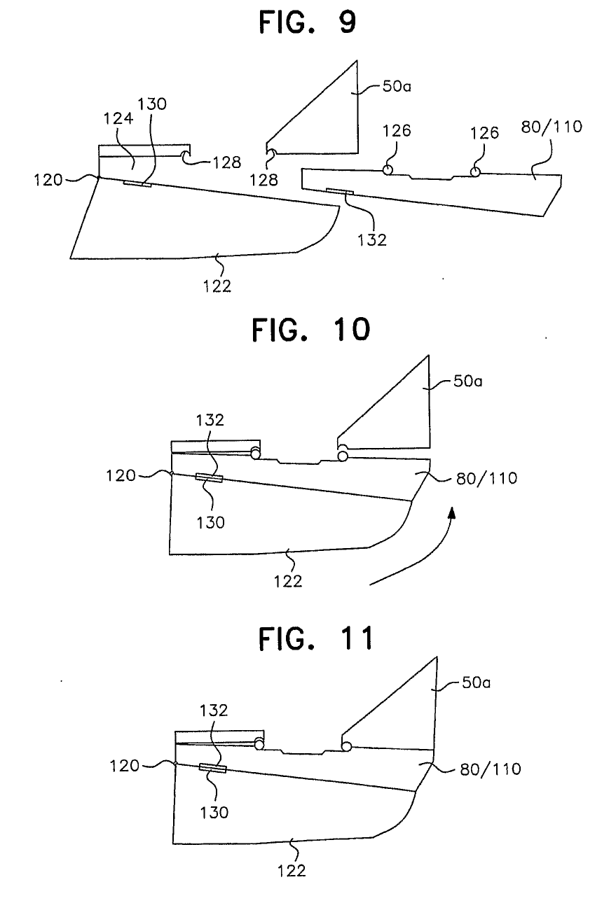

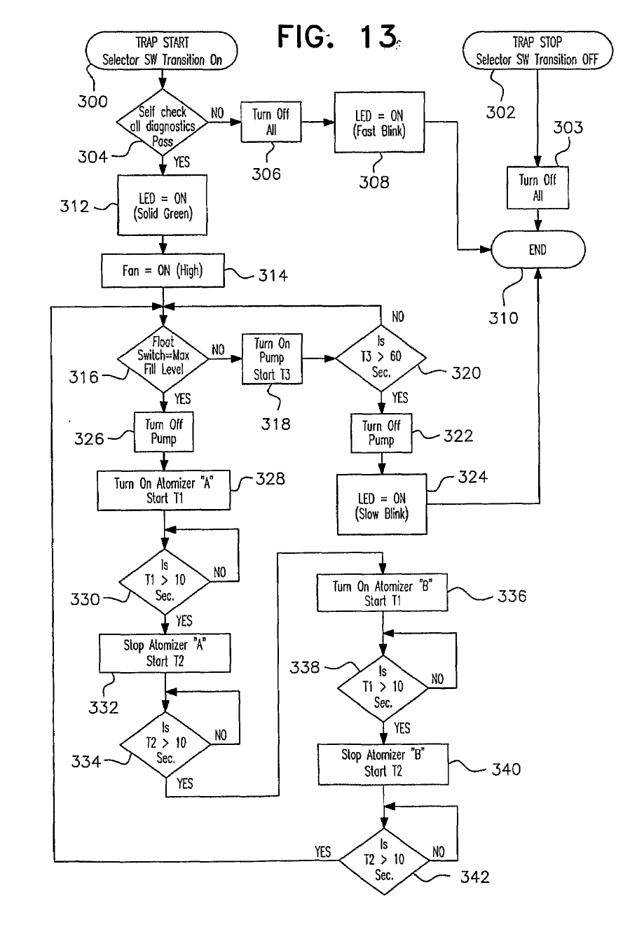

FIGS. 9-11 show an alternative embodiment especially designed for enabling easy removal and replacement of a fog generator 80/110. FIG. 9 is a schematic view of a mounting arrangement for removably mounting a fog generator in an open position with the fog generator 80/110 partially inserted. FIG. 10 shows the fog generator fully inserted into the mounting arrangement of FIG. 9. FIG. 11 shows the fog generator 80/110 fully inserted into the mounting arrangement of FIG. 9 in the closed position.

In these Figures, the bottom wall 122 of the reservoir 50a is hingedly connected at pivot 120. This enables the wall 122 to be pivoted down to an open position, as shown in FIG. 9. In this condition, the fog generator 80/110 can be easily removed or replaced in the space shown at 124. In FIG. 10, the fog generator 80/110 is inserted into that space 124, and the bottom wall 122 is still pivoted to its open position. In FIG. 11, the wall 122 is pivoted up to place the fog generator 80/110 in its operative position. A suitable latch or lock (not shown) may be provided to secure the wall 122 in this closed position.

As can be seen from these Figures, an annular seal or gasket 126 is mounted to the upper part of the fog generator 80/110, and a corresponding groove 128 is provided on the undersurface of the reservoir where the generator 80/110 will mount. The seal 126 is received in the groove 128 to create a seal that prevents liquid/attractant from leaking out the bottom of the reservoir 50a. Any other suitable sealing may be used and the illustrated construction is not intended to be limiting.

Optionally, a contact member 130 maybe provided on wall 122 (or any other wall defining space 124), and a corresponding contact member 132 may be provided on the generator 80/110. Contact member 130 would be connected to the electrical power supply, typically through the controller 70. Contact member 132 would be connected to the active elements of the fog generator 80/110. When the contact members 130, 132 are engaged, power can be delivered through that connection. Likewise, when the contact members 130, 132 are disengaged, power delivery would be interrupted. The use of contact members 130, 132 positioned as shown avoids the need for establishing a separate connection, as the power connection is established simply by mounting the fog generator 80/110 in its operative position.

This variation for easier removal and replacement of the fog generator 80/110 is entirely optional.

When generating the fog F, it is desirable to control the size of the droplets for enhancing the ability to attract insects. As an example, it is desirable to generate the fog such that fog such that at least 50% or more of droplets in the fog are 3 microns or less in diameter. More preferably, 65% or more are 3 microns or less in diameter, and even more preferably 70% or more are 3 microns or less in diameter. Other suitable ranges may be used. For example, it is preferable to have 60% of the droplets be less than 5 microns in diameter, and more preferably to have 70% of the droplets be less than 5 microns in diameter. Likewise, it is desirable to generate the fog such that at least 40% of droplets in the fog are 1.5 microns or less in diameter, and more preferable to have at least 50% of the droplets 1.5 microns of less in diameter.

The preferred (but not necessary) temperature range for the fog exiting the device (i.e., as it exits the outlet opening) is 90° F.+/−15%, preferably 90° F+/−10%.

Another embodiment of this invention relates to a liquid insect attractant composition containing at least one C₃-C₁₂ ketone, an aqueous solution of lactic acid, and at least one C₁-C₉ fatty acid. The liquid insect attractant composition should (a) be miscible in water, and (b) have a surface tension less than about 70 dynes/cm at 20° C., as measured by a Fisher Surface Tenisometer Semiautomatic Model 21 Tensiomat. The liquid insect attractant should be in a diluted form to exhibit a surface tension less than about 70 dynes/cm at 20° C.

As set forth earlier, the lower surface tension of the liquid insect attractant composition allows the composition to produce smaller, more consistent droplets when released from a suitable apparatus. While surfactants are useful at lowering the surface tension in a liquid composition, the surface tension can be lowered by adding certain solvents or organics known in the art. For instance, using acetone in the liquid composition has been found to lower the surface tension. Preferably, the composition has a surface tension of less than about 70 dynes/cm at 20° C., more preferably, less than about 60 dynes/cm at 20° C.

The insect attractant composition should be miscible with water so that it can be easily mixed with water and then released. The more miscible the insect attractant composition is with water, the easier the two liquid compositions can be combined and then released. Using an insect attractant composition that is not or less miscible with water can be problematic if it is desirable to release the composition in a diluted form in that additional mixing steps and/or additional component would likely be necessary before the combined mixture is suitable for release. These additional steps and/or additional components can add time and expense, all of which can be obviated by using an insect attractant composition that is miscible in water.

What is claimed is:

1. A liquid insect attractant composition, comprising:
a. at least one C₃-C₁₂ ketone
b. at least one C₁-C₉ fatty acid, and
c. an aqueous solution of lactic acid,
wherein the fatty acid potentiates the insect-attractant properties of the lactic acid.

2. The composition of claim 1, wherein the ketone is selected from the group consisting of acetone, methyl ethyl ketone, 2-methyl-3-octanone, 2-pentanone, 3-pentanone, and combinations thereof.

3. The composition of claim 1, wherein the fatty acid contains at least one C₂-C₆ fatty acid.

4. The composition of claim 3, wherein the fatty acid is selected from the group consisting of propionic acid, valeric acid, 2-methylbutanoic acid, 3-methylbutanoic acid, and combinations thereof.

5. The composition of claim 4, wherein the fatty acid is a mixture of propionic acid and valeric acid.

6. The composition of claim 1, wherein the ratio of the fatty acid to the lactic acid ranges from 1.0 E⁻⁰⁹:1 to 1.0 E⁻⁰⁴:1.

7. The composition of claim 1, wherein composition is present as a concentrate.

8. The composition of claim 7, wherein the weight percentage of the fatty acid ranges from about 1.0 E⁻⁰⁹ to about 1.0 E⁻⁰¹, based on the total composition weight.

9. The composition of claim 1, further comprising water so as to form a diluted composition.

10. The composition of claim 9, wherein the weight percentage of water in the diluted composition ranges from about 75 to about 99, based on the total diluted composition weight.

11. The composition of claim 1, further comprising at least one surfactant.

12. The composition of claim 11, wherein the surfactant is selected from the group consisting of alkyl ammonium salts, polyethylene glycol fatty acid esters, polyglycerol fatty acid esters, sugar esters, sugar ethers, derivatives thereof, and combinations thereof.

13. A method of attracting insects, comprising:
a. providing a liquid insect attractant composition comprising at least one C₃-C₁₂ ketone, an aqueous solution of lactic acid, and at least one C₁-C₉ fatty acid;
b. providing an apparatus containing a supply capable of holding and releasing the liquid insect attractant;
c. housing the insect attractant composition in the apparatus; and
d. releasing the liquid insect attractant composition from the apparatus in a manner that creates droplets having an average particles size of about 5 microns or less.

14. The method of claim 13, wherein the average particle size is about 2.5 microns or less.

15. The method of claim 14, wherein the average particle size is about 1.5 microns or less.

16. The method of claim 13, wherein the apparatus is an insect-trapping apparatus.

17. The method of claim 16, wherein the insect-trapping apparatus comprises a feeder for feeding the insect attractant composition and a second liquid, and a fog generator that is in communication with the feeder.

18. The method of claim 17, wherein the releasing step is operated via the fog generator.

19. The method of claim 13, wherein the ketone is selected from the group consisting of acetone, methyl ethyl ketone, 2-methyl-3-octanone, 2-pentanone, 3-pentanone, and combinations thereof.

20. The method of claim 13, wherein the fatty acid is selected from the group consisting of propionic acid, valeric acid, 2-methylbutanoic acid, 3-methylbutanoic acid, and combinations thereof.

21. A liquid insect attractant composition, comprising: at least one C₃-C₁₂ ketone, an aqueous solution of lactic acid, and at least one C₁-C₉ fatty acid; wherein the liquid insect attractant composition
a. is miscible in water, and
b. has a surface tension less than about 70 dynes/cm at 20° C.

22. The composition of claim 21, wherein the surface tension of the composition is less than about 60 dynes/cm at 20° C.

23. The composition of claim 21, wherein the ketone is selected from the group consisting of acetone, methyl ethyl ketone, 2-methyl-3-octanone, 2-pentanone, 3-pentanone, and combinations thereof.

24. The composition of claim 21, wherein the fatty acid is selected from the group consisting of propionic acid, valeric acid, 2-methylbutanoic acid, 3-methylbutanoic acid, and combinations thereof.

25. The composition of claim 21, further comprising at least one surfactant.

26. The composition of claim 25, wherein the surfactant is selected from the group consisting of alkyl ammonium salts, polyethylene glycol fatty acid esters, polyglycerol fatty acid esters, sugar esters, sugar ethers, derivatives thereof, and combinations thereof.
